(19) United States
(12) Patent Application Publication
(10) Pub. No.: US 2016/0023772 A1
(43) Pub. Date: Jan. 28, 2016

(54) ULTRASONIC VIBRATION SYSTEM AND METHOD FOR REMOVING/AVOIDING UNWANTED BUILD-UP ON STRUCTURES

(71) Applicant: FBS, Inc., State College, PA (US)

(72) Inventors: Cody J. Borigo, Pennsylvania Furnace, PA (US); Joseph L. Rose, State College, PA (US); Steven E. Owens, Bellefonte, PA (US)

(21) Appl. No.: 14/329,426

(22) Filed: Jul. 11, 2014

Related U.S. Application Data
(60) Provisional application No. 61/858,720, filed on Jul. 26, 2013.

(51) Int. Cl. B64D 15/16; G01N 27/02; B08B 7/02

(52) U.S. Cl. CPC B64D 15/16; B08B 7/028; G01N 27/02

(57) ABSTRACT

A method includes calculating, using a processor, an impedance or forward and reflected power coefficients of a phased system including a plurality of actuators disposed on a structure; and activating the plurality of actuators disposed on the structure to produce shear stress via ultrasonic continuous wave activation to at least one of delaminate or weaken an adhesion strength of a contamination on the structure.

### CROSS-REFERENCE TO RELATED APPLICATIONS

This application claims priority to U.S. Provisional Patent Application No. 61/858,720, filed Jul. 26, 2013, the entirety of which is incorporated by reference herein.

### FIELD OF THE INVENTION

Aspects of the invention relate to deicing, anti-icing, de-contamination, or contamination prevention for structures where such capability would be beneficial. The technique invented here could also be utilized in non-destructive testing and structural health monitoring applications.

### BACKGROUND INFORMATION

Ice formation on structures and components can cause decreases in component performance and, in some cases, component failure. Ice formation on helicopter rotor blades or on the wing leading edges of fixed-wing aircraft, for example, alter the aerodynamic characteristics of the aircraft and can result in reduced handling. Icing conditions, for the case of aircraft, often result in flight cancellations or delays. In the event that icing conditions are encountered during flight, ice build-up, which reduces aircraft handling and maneuverability, can cause the aircraft to crash.

Thermal deicing and pneumatic boot systems are used predominantly for structural deicing. These systems require significant power levels for operation. For the case of rotorcraft, the high power levels required by the thermal systems result in compromised rotorcraft functionality. Further, the thermal deicing systems often melt ice which then refreezes on other parts of the blade, wing, or component. Therefore, a need exists to replace thermal deicing systems with new technologies that require less power.

In addition to rotor blades and wing leading edges of fixed-wing aircraft, many other structures would benefit from a low-power deicing or anti-icing system, including, but not limited to, windshields in aircraft, automobiles, and other vehicles, ship hulls or other ship components, heat exchangers and other tubing where frost or ice could form, air-conditioning components, head lamp and other light coverings, and bridge structures and components.

The buildup of dirt, mud, frozen soil, or other debris on structures can cause reduced functionality and increased weight. For example, excavation equipment can be difficult to start and operate if debris accumulates on the undercarriage of the equipment or vehicle. For excavation equipment, debris formation is sometimes mitigated by debris-phobic coatings which do not always work well and can wear overtime. Debris removal is often achieved using an object to strike the undercarriage to shake the debris loose. Using this time-consuming approach, project delays are often caused.

For excavation equipment, it would be beneficial to have debris prevention or removal technology that could be used during or after equipment use to prevent debris formation or quickly remove debris build-up.

Another example where debris build-up causes unwanted downtimes and increased cleaning costs is in the food industry where bacteria or other films can accrete to the inner diameter surface of tubing or pipes used to transport product. These tubes or pipes are routinely shut down and flushed with cleaning chemicals to remove unwanted build-up. There is a need to provide a technology to prevent build-up formation or assist the cleaning process in removing these films.

### SUMMARY

In some embodiments, a method and arrangement are provided for removing or preventing the formation of ice, mud, or other debris or contaminants, from structures where such capability would be beneficial.

In some embodiments, the amount of power required for ice, mud, debris or contamination removal or prevention is reduced via appropriate ultrasonic actuator design to excite specific ultrasonic modes in the structure.

In some embodiments, the overall area of coverage for prevention of contamination and decontamination activities is improved by using frequency tuning, over some frequency range and at some frequency increment, to change the structural areas where maximum ultrasonic stresses occur when considering the ultrasonic stresses produced in the structure from one or more actuators.

In some embodiments, frequency tuning is used to occasionally drive the actuator off-resonance to avoid over-heating or degradation of the actuator.

In some embodiments, the overall area of coverage is improved by using multiple actuators combined with phased array focusing, using tone-burst pulse excitation, or time delay phasing, using continuous wave excitation, in the waveguide structure being considered to move the ultrasonic stress focal points around the structure.

In some embodiments, a tone burst or chirp input to the actuator, or actuators, is used to improve performance. The objectives are achieved as illustrated and described. In one embodiment, a method is provided including the steps of encompassing placing at least one ultrasonic actuator on the host structure and determining a special loading function to create a shear stress, normal stress, or other wave mechanics parameter in the host structure. The method further provides for activating the at least one ultrasonic actuator on the host structure to produce the shear stress via ultrasonic continuous wave activation, wherein at least one of ultrasonic initial transient wave propagation, reflection factor superposition, and time modal vibrations are used to at least one of delaminate and weaken an adhesion strength of the contamination to the host structure.

In some embodiments, a novel ultrasonic vibration technique for nondestructive testing or structural health monitoring purposes is used whereas a modal analysis approach is used for detection but transient wave analysis is used to select a particular guided wave mode, with a specific wave structure, to achieve improved detection sensitivity.

In some embodiments, a method for at least one of removing and preventing ice from attaching to a host structure is provided. In this example embodiment, the method provides for the steps of one of permanently installing and periodically placing at least one ultrasonic actuator on the host structure, and activating the at least one ultrasonic actuator on the host structure to one of remove the ice from the host structure, decrease an adhesion strength of ice layers from the host structure and prevent ice from forming on the host structure

In another example embodiment, a method for at least one of removing and preventing contaminants from attaching to a host structure is provided. In this example embodiment, a method step of one of permanently installing and periodically placing at least one ultrasonic actuator on the host structure is provided. Additionally, the method provides for activating the at least one ultrasonic actuator on the host structure to provide ultrasonic stresses in the host structure to one of remove the contaminants from the host structure, decrease an adhesion strength of the contaminants from the host structure and prevent contaminates from forming on the host structure are provided.

In some embodiments, a method includes monitoring a forward power and a reflected power between one or more amplifiers and at least one actuator, optimizing a frequency of excitation and a matched impedance of an ice/contaminant removal system, and activating the at least one actuator disposed on a structure to produce a shear stress via ultrasonic continuous wave excitation to one of delaminate or weaken an adhesion strength of a contamination disposed on the structure.

### BRIEF DESCRIPTION OF THE DRAWINGS

FIG. 1 illustrates a sample phase velocity dispersion curve showing activation lines for different loading scenarios.

FIG. 2 illustrates a comb or annular array actuator arrangement, wherein the finger spacing dictates the mode that will be excited.

FIG. 3 is an annular array actuator design.

FIG. 4 is a shear polarized actuator, wherein the actuator is poled through the length and an electric field is applied across the width to operate in a d₁₅ configuration.

FIGS. 5A and 5B are examples of shear horizontal phase velocity dispersion curves for an aluminum skin with adhered ice layers.

FIG. 6 illustrates a wave structure for a guided wave mode exhibiting large interface shear stresses.

FIG. 7 illustrates a wave structure for a guided wave mode exhibiting small interface shear stresses.

FIG. 8 shows an arrangement for a sample finite element method model used to predict the shear stresses produced at the interface of a steel plate with ice layers present.

FIG. 9 illustrates a sample finite element method modeling result predicting the shear stresses produced at the plate/ice layer interface.

FIGS. 10A, 10B and 10C illustrate the removal of ice layers from a steel plate using the ultrasonic frequency tuning approach.

FIG. 11 is a schematic illustration of one non-limiting embodiment of an ice/contaminant removal system in accordance with some embodiments.

FIG. 12 is a bar graph of finite element results illustrating the change in average shear stress across an ice-substrate interface of an airfoil using 30 different actuator phasing combinations at the respective phased system resonance for each phasing combination.

FIG. 13 illustrates finite element results of several interfacial shear stress distributions on an ice-coated airfoil during phasing at the respective phased system resonances.

FIG. 14 illustrates a subset of impedance curves measured in a four-actuator system, the directly-measured system impedance, and the system impedance calculated using a method described herein.

FIG. 15 illustrates an increase in interfacial shear stress in an ice-substrate system achieved with an increasing number of actuator phasing combinations.

FIGS. 16A and 16B illustrate a 1:1 transformer used to invert an actuator excitation signal for phase inversion as well as example input and output waveforms illustrating the phase shift induced by the transformer.

FIG. 16C illustrates one example of a center-tapped transformer configured as a phase splitting circuit in accordance with some embodiments.

FIG. 17 illustrates one example of a method of fabricating an actuator and bonding the actuator to a structure in accordance with some embodiments.

FIG. 18 illustrates one example of an actuator fabricated using the methods described herein in accordance with some embodiments.

FIG. 19 illustrates one example of an actuator bonded onto a curved surface using an intermediary wedge and film epoxy in accordance with some embodiments.

FIG. 20 illustrates one example of a concept of continuous wave time delay phasing between actuators in accordance with some embodiments.

FIG. 21 shows one example of two actuators bonded to a structure in accordance with some embodiments.

FIG. 22 is a flow diagram of one example of a method for removing and/or avoiding unwanted build-up on structures in accordance with some embodiments.

### DETAILED DESCRIPTION

In one non-limiting method in accordance with some embodiments, a phase velocity dispersion curve space is developed for a structure, in this example called a host structure. The host structure can be an airplane wing, a boat, a structural steel skeleton of a building, or other. The phase velocity dispersion curve space is then evaluated with respect to either a longitudinal wave (“Lamb type wave”) or shear horizontal wave case for the structure such that activation produces a Lamb type wave or shear horizontal wave in the structure by using a specific actuator design. The appropriate point chosen on the velocity dispersion curve space is based on the wave structure across the thickness of the substrate/ice or substrate/contaminant structure. Maximum or reasonable shear stress or normal stress is generated at that point chosen on the velocity dispersion curve space in order to fracture, delaminate, or weaken the interface between ice or materials adhering to the host structure substrate. An angle beam, comb type, normal beam longitudinal, vertical shear, or horizontal shear actuator may be used to create the maximum or reasonable shear stress for the fracture or delamination. In one example embodiment, an ultrasonic vibration method may be used whereby continuous wave excitation is produced.

In the methods and systems provided, actuator positioning on the host structure is important as the transient wave generated by the transducers starts traveling through the host structure with a suitable wave structure. As the wave encounters boundaries, the wave is reflected at various angles. The initial wave patterns are complex but eventually, after many reflections and as the wave travels from one boundary to another, a modal pattern is established at a resonant frequency. There are many resonant frequencies fairly close together because of the ultrasonic excitation. Deicing or decontamination can often occur at a resonant or a non-resonant situation.

With appropriate test points from the dispersion curves for the structures, the wave structure is preserved, with respect to suitable stress at the ice/substrate or ice/contaminate interface, after the many reflections leading to the vibration state. The ice or contaminant is removed as a result of ultrasonic transient waves, reflection factors, and eventual vibrations that, via continuous interference of the wave pattern, produce sufficient shear stress at the ice/substrate or ice/contaminant interface to cause fracture and delamination. The vibration pattern depends on the initial specifically designed ultrasonic loading functions.

In one embodiment, the ultrasonic guided wave is launched using an ultrasonic actuator with minimal input energy to achieve deicing or decontamination of a surface. This method and configuration solves the long felt need of decontamination without need for large input energies into the host structure.

Deicing or decontamination is achieved by providing sufficient shear or normal stresses, or combination thereof, at the ice, mud, and/or debris—substrate interface at the ultrasonic guided wave launching point and possibly over the entire structure being considered.

The electromechanical impedance of the actuator-ice/contaminant-structure system may be periodically measured in order to adjust the actuator driving parameters including frequency and impedance matching. The system may be driven at one or more of the frequencies at which an impedance minimum occurs, which are the resonant frequencies associated with the electromechanical system, or in some embodiments, at off-resonant frequencies. As material is disbonded, cracked, removed, or otherwise altered, and as the actuators may heat up during operation, the electromechanical resonance characteristics of the system change, thus the system impedance is monitored in order to operate the system effectively and efficiently. In some embodiments, in lieu of or in addition to direct electromechanical impedance measurements, monitoring of the forward and reflected power between the amplifier(s) and actuator(s) can be used to identify the optimum frequency of excitation. These measurements may be acquired from the amplifier(s) using a bi-directional coupler or similar circuitry. The method by which the power information is applied to optimize the excitation frequency may be via periodic adjustment or by continuous tuning. If this type of frequency optimization is applied instead of direct impedance monitoring, measuring the phased impedance can be omitted.

One or more actuators with proper physical positioning may be considered in order to alter wave interference phenomenon to create a number of maximum constructive interference zones or focal points that could be moved around the structure as frequency and/or wave mode is changed, resulting in the creation of natural focal spots. These focal points may be moved, through user selection, allowing deicing/decontamination at specific points of the structure.

In an alternative configuration and method, phased array focusing, using tone-burst pulse excitation, or time delay phasing, using continuous wave excitation, in the wave guide structure being considered may be used to move the focal points around the structure, thus allowing a user to select where material removal occurs.

The central driving frequency and impedance matching of the system are adjusted upon actuator phasing iteration based on a new phased system impedance curve.

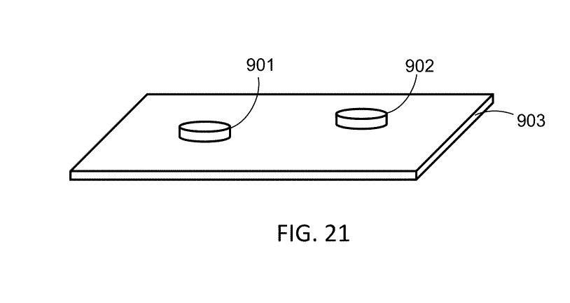

When time delay phasing using continuous wave excitation is employed, the phased system impedance characteristics are dependent upon the specific actuator phasing combination that is utilized, i.e., the relative phase(s) applied to individual actuators, as is illustrated in FIG. 20. Upon utilization of a particular phasing combination, the new phased system impedance is measured. Conventionally, this was difficult or impossible to do directly using an impedance analyzer as it cannot account for the out-of-phase activation of the various actuators. However, a method is disclosed herein to calculate the phased system impedance by measuring a subset of actuator impedances and cross-impedances. Here impedance is a complex value defined as the ratio of voltage applied across a load divided by the current that flows across that load, and cross-impedance is defined as the ratio of voltage applied across an actuator 901 divided by the current that is induced across another actuator 902, in which actuators 901 and 902 are mechanically coupled through an intermediary structure 903, as is illustrated in FIG. 21. By measuring the impedance Zᵢ of each individual actuator, i, as well as the cross-coupled impedances Zᵢⱼ between actuators i and j (defined as the current induced in actuator j divided by the voltage applied to actuator i, the correct system impedance can be calculated using the equation below. Here Z signifies the system impedance, Zᵢⱼ signifies the cross-coupled impedance due to current Iᵢⱼ, which is the current induced across actuator j due to voltage applied across actuator i, φᵢ is the phase applied to actuator i and N signifies the total number of actuators in the system.

$$Z = {[ {\sum }_{n = 1}^{N} {\sum }_{m = 1}^{N} \frac{1}{{Z}_{n m}} {e}^{- i ( {ϕ}_{n} + {ϕ}_{m} )} ]}^{- 1} \qquad Eq . ( 1 )$$

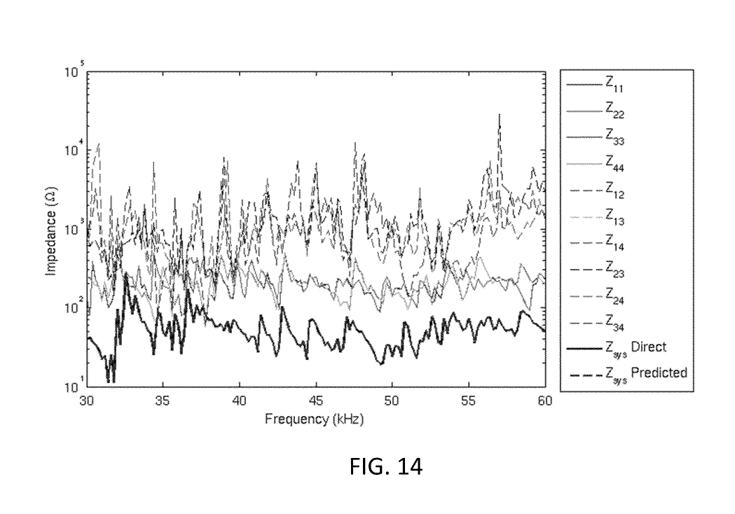

One example of a result illustrating the individual impedances and the predicted and actual impedance curves for a given structure are shown in FIG. 14. Applying the appropriate phase shift to the complex-valued impedance curves of each actuator and for the complex-valued cross-coupled impedance curves of each unique pair of actuators allows the phased impedance curve of the system to be calculated for any arbitrary phasing combination.

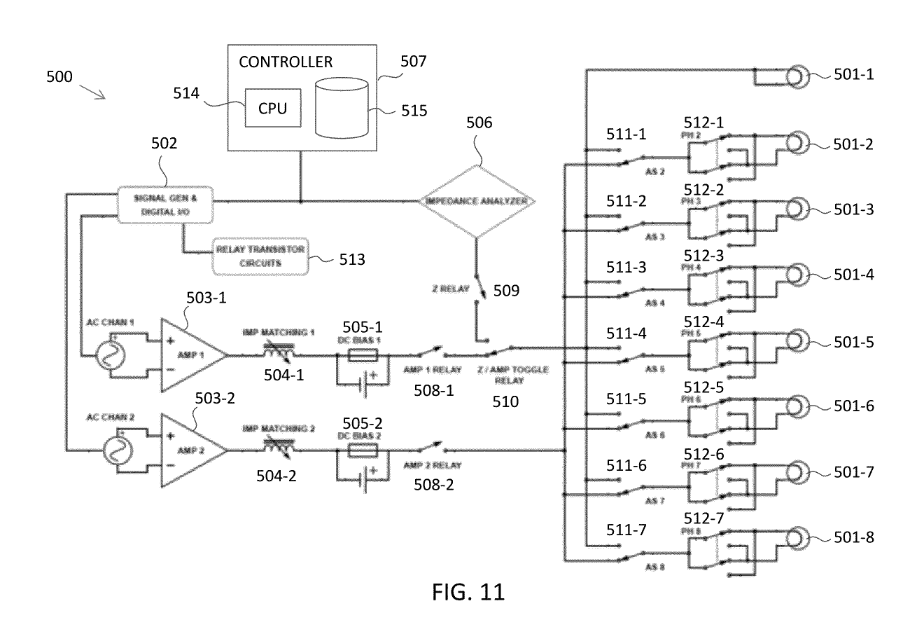

Another method of measuring the phased system impedance is to utilize only 180° phasing increments (referred to here as phase inversion or reversal) and, during impedance measurement, to physically reverse the polarity of each actuator or actuator set to which phase inversion will be applied. This method of impedance measurement accounts for the effects of actuator phasing on the phased system impedance curve. The polarity may then be returned to its original state before applying power to the actuators. It can be shown that comparable stress coverage and power reduction can be achieved using this phase inversion technique as is achievable with arbitrary phasing combinations. This polarity inversion may be achieved with a double-pole double-throw relay in one embodiment, such as the phase inversion relays 512 in FIG. 11, which is described in greater detail below.

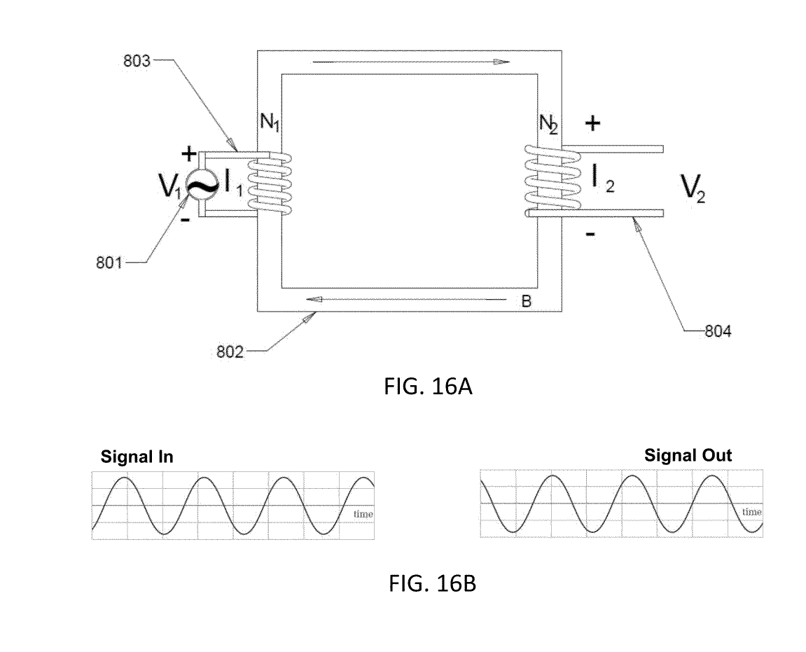

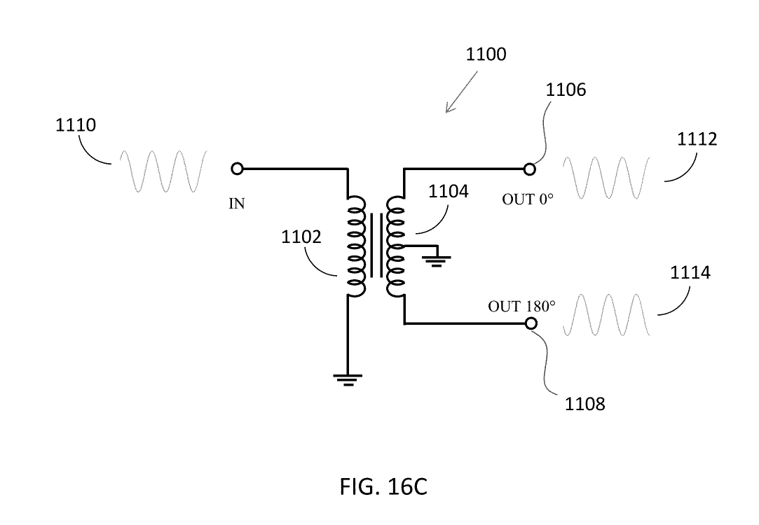

In some embodiments, if phase inversion or reversal is utilized, i.e., 180° phasing increments are applied, a system includes circuitry comprising two independent sets of amplifiers, signal generator channels, impedance matching networks, and, potentially, additional components. One set of these independent components are used for the in-phase actuators and one set of amplifiers are used for the out-of-phase actuators. In order to reduce the cost, weight, and size of the system, a single set of such components may be used and 180° phasing may be accomplished by one or more 1:1 transformers 802. The signal phase inversion is achieved by wrapping the secondary coils 804 with an equal number of turns as the primary coils 803, but in the opposite direction, as is shown in FIGS. 16A and 16B described in greater detail below. In some embodiments, transformer 802 are coupled to circuitry of system 500, which is described below with respect to FIG. 11.

In some embodiments, signal phase inversion is achieved using other phase splitting circuits. For example, FIG. 16C illustrates one example of a center-tapped transformer 1100 configured to perform phase splitting. As shown in FIG. 16C, center-tapped transformer 1100 includes a first coil 1102 coupled to an input node, IN, and to ground. A second coil 1104 is coupled to a pair of output nodes 1106, 1108. Coil 1104 is center tapped with the center tap being coupled to ground. Input node IN receives an oscillating input signal 1110 and output nodes 1106, 1108 respectively output signals 1112, 1114 that are shifted relative to one another, e.g., signal 1112 has a zero degree phase shift and signal 1114 has a 180 degree phase shift. In some embodiments, anti-phase signals 1112, 1114 are sent to two sets of actuators to achieve actuator phasing. A person of ordinary skill in the art will understand that other phase splitting circuits, such as a split-load amplifier and a different pair amplifier, can also be implemented.

Ice, mud, and/or debris delamination from the structure and/or cracking occur as a result of sufficient shear stress, normal stress, or other wave mechanics parameter being provided to the ice, mud, and/or debris-substrate interface in combination with frequency tuning, tone burst excitation phased array focusing, continues wave excitation time phasing, wave reflection factor superposition with waves emitted from the actuator, and/or vibration modes generated as a result of numerous reflections from the boundaries of the structure.

Aspects of specific ultrasonic mode and frequency excitation over a finite frequency range from 1 Hz-500 MHz are provided wherein frequency tuning over a selected specific frequency range, phased array, time phasing, or natural focusing achieved via optimal sensor positioning, reflection factor point constructive interferences and special modal vibration combination releases, and possible use of ice or mud phobic coatings in combination with the features of the above-described system.

Either one or a combination of some or all of these concepts may be used for ice, mud, and/or debris prevention or removal, depending on the situation. For example, ice or debris type or thickness, structural geometry, environmental conditions, etc. will affect which concepts are applicable.

The apparatus and methods provided can be applied to isotropic media as well as anisotropic composite media. Further, various combinations of these concepts can be selected so as to not cause structural damage.

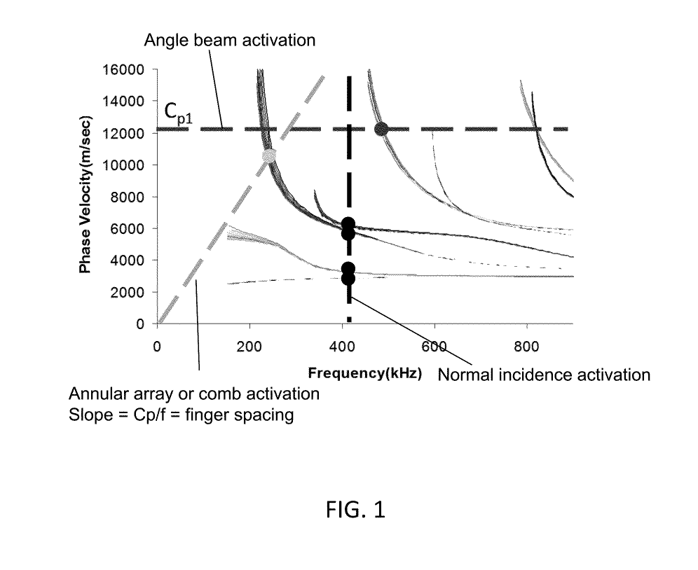

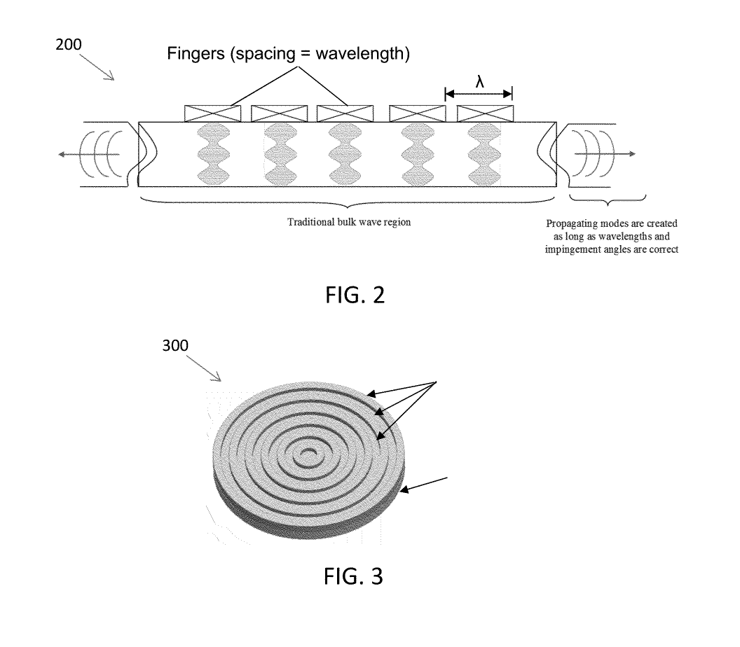

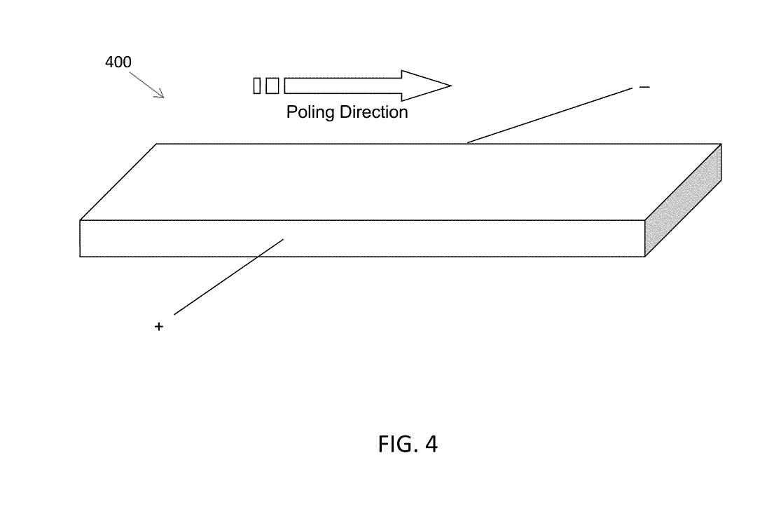

Optimal actuator design and actuator frequency for providing large shear stresses, normal stresses, or other wave mechanics parameter to the ice, mud, and/or debris interface can be achieved using analytical dispersion curve and wave structure analysis in combination with finite element method modeling. Actuator designs that can be considered non-limiting embodiments include, normal incidence loading using either shear polarized piezoelectric elements or conventional disks or bars poled through the thickness, angle beam loading to excite specific points on the guided wave phase velocity dispersion curve, or annular array or comb actuators, again, to provide specific mode control. For the case of normal loading, mode control is limited and the actuator will excite some component of all guided wave modes present at the actuator driving frequency. Angle beam loading can be used to excite specific guided wave modes according to Snell's Law. Annular array or comb actuators can also be used to excite specific points in the dispersion curve space by designing the finger spacing of the probe to be equal to the wavelength of the mode you wish to excite. As an example, FIG. 1 shows the activation lines on the phase velocity dispersion curve for each type of loading. FIG. 2 demonstrates the concept of a comb actuator and FIG. 3 shows an annular array actuator. FIG. 4 demonstrates the concept of a shear polarized actuator for operating in the d₁₅ configuration.

In some embodiments, basic curves associated with this phenomenon for ice layers of thicknesses 1 mm and 2 mm on an aluminum skin in FIG. 1 are provided.

The design, location, and configuration of the one or more actuators affect the successful design of an ice/contaminant removal/prevention system that will function effectively and efficiently with minimal required input power. In order to optimize such a system by analyzing a number of actuator configurations over various actuator phasing combinations, many computationally-expensive and time-consuming finite element calculations must be performed with a large number of potential actuator phasing combinations. The number of finite element calculations required to do so is in most cases prohibitive. A method is disclosed herein by which a smaller subset of finite element calculations may be performed. Using this method, the results of the specially-selected subset of calculations can be combined using the phased impedance calculations described above and stress field superposition to yield finite element results for any possible actuator phasing combination. This method allows for faster and more practical actuator design and actuator configuration design.

In order to reduce the chances of actuator mechanical failure, a DC bias may be applied to the voltage signal to operate the actuators in a state of varying compression. Since the compressive strength of most piezoelectric materials is much greater than the tensile strength, this method allows for greater peak-to-peak voltages to be applied to the actuator without failure by cracking.

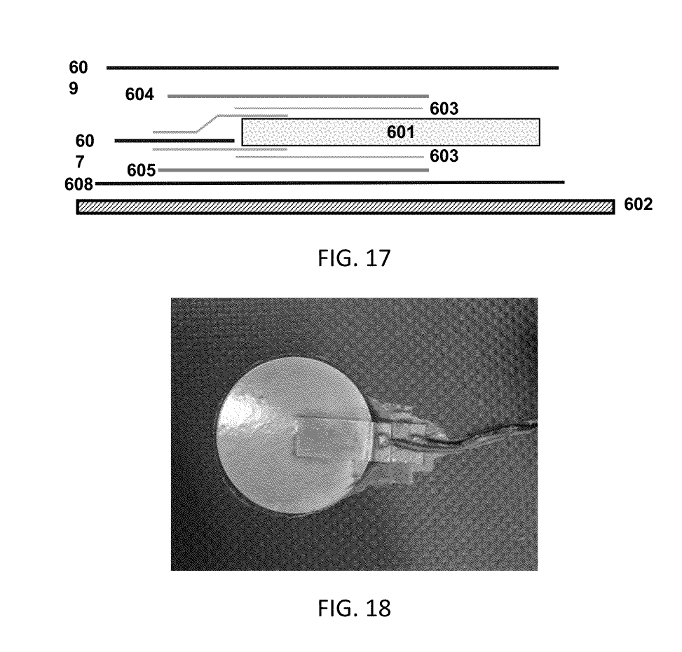

The piezoelectric actuators utilized in the system generally include two electrode connections on opposite faces of the actuator. Connecting these actuator electrodes to the circuitry of the system can be difficult and if not done properly can lead to actuator failure. Soldered connections on the face(s) of the actuator act as stress concentrators that often cause the entire actuator to fracture. To overcome this issue, solder-less connections, i.e., connections in the absence of solder, can be used. In some embodiments, as is illustrated in FIG. 17, for example, a thin layer of low-viscosity epoxy 603 is used to bond thin copper foil tabs 604 and 605 to the electrodes of the actuator 601 and is cured under pressure. The combination of low epoxy viscosity and applied pressure lead to an ultra-thin bond line with numerous microscopic regions in which the actuator electrodes contact the copper tab to complete the electrical connections on each face. Multiple layers of film epoxy 607 and 608 are utilized to isolate the positive and negative electrode tabs from each other and from the structure to which the actuator is bonded, which may be conductive, as well as to bond the actuator to the structure 602. One or more layers of film epoxy 609 may also be used to isolate the exposed electrode of the actuators and to bond the actuators to the structure. This method results in an isolated actuator that is less prone to fracture. This method is illustrated in one embodiment in FIGS. 17 and 18.

In one embodiment, the system is triggered by an ice/contaminant sensing system which is achieved by use of the system actuators or by a supplementary set of sensors. This sensing system may be operated periodically to evaluate the effectiveness of the ice/contaminant removal/prevention in real time. In some embodiments, a sensing system operates by identifying changes in the electromechanical impedance of the system induced by ice accretion or by utilizing separate transducers, which are designed for such sensing, to send and receive transient ultrasonic guided waves, which are subsequently analyzed using one or more signal processing techniques to identify the presence of ice.

Referring to FIG. 1, a sample phase velocity dispersion curve is shown with the activation lines for normal, angle beam, and comb loading. For a case of normal incidence, mode control is limited and the actuator will excite components of all modes present at the driving frequency. For a case of angle beam incidence, the angle of incidence can be determined using Snell's Law and the phase velocity of the desired wave mode. Once the incident angle is set, a horizontal activation line can be drawn on the dispersion curve and all modes intersecting the line can be excited by changing excitation frequency. For the case of comb activation, the activation line is drawn as shown with a slope equal to the wavelength or comb finger spacing. Again, all modes intersecting the activation line can be excited with the actuator by changing excitation frequency. The use of angle beam or comb activation is advantageous in that a single mode on the dispersion curve with a desired wave structure can be selected and the actuator can then be designed to excite the desired mode, and no other modes.

Referring to FIG. 2, a comb probe 200 is shown. The fingers in the probe 200 are designed to be one wavelength apart, depending on the mode and corresponding wavelength one chooses to excite.

FIG. 3 shows a drawing of an annular array actuator 300 in one non-limiting embodiment. The annular array 300 is equivalent to a comb actuator and finger spacing is chosen in the same manner. In this embodiment, an electrode pattern is placed on top of a piezoelectric disk to create the desired wave mode as selected by a user.

FIG. 4 shows a conceptual drawing of a shear polarized actuator 400. The actuator 400 is poled through the length and an electric field is applied across the width to operate in the d₁₅ configuration. Each of the shear polarized actuator 400, the annular array actuator 300 and the comb probe 200 may be attached in a permanent manner to a host structure or temporarily attached to a host structure for actuation of host structure. The actuation may be used, in example embodiments, to limit/remove contamination, such as ice, mud and materials from a surface that is desired to be clean.

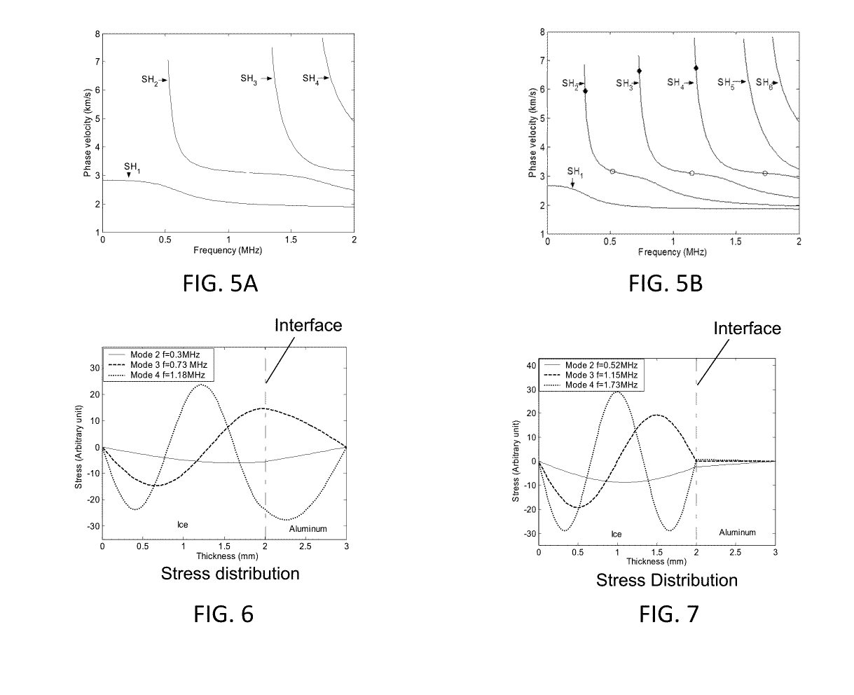

FIGS. 5A and 5B are examples of the ultrasonic guided wave phase velocity dispersion curves for an aluminum skin host structure with an ice layer frozen to the surface of the aluminum skin. Two ice layer thicknesses are represented in the curves. The curves have shifts as ice thickness varies. The dispersion curves represent possible transient wave guided wave modes that can be generated in this structure as a function of excitation frequency. Each point on the curve can be excited via special actuator design. Each point on the curve also has a different wave structure associated with it. Wave structure here refers to different displacement characteristics through the thickness of the part or aluminum skin. In addition to shear horizontal dispersion curves, Lamb wave dispersion curves can also be generated and analyzed similarly. Both types of dispersion curves can be generated for any substrate structure exposed to any ice layer or contaminant type or thickness.

FIG. 6 illustrates a shear stress distribution across the thickness of the aluminum skin host structure with ice layer for several selected points on the dispersion curve. In this example, mode 4 has a wave structure with relatively high shear stress at the aluminum plate/ice interface while mode 2 provides relatively low shear stress to the aluminum/ice interface.

FIG. 7 shows a shear stress distribution across the thickness of the aluminum skin with ice layer for several selected points on the dispersion curve. In this case, all of the modes provide low shear stress values to the interface.

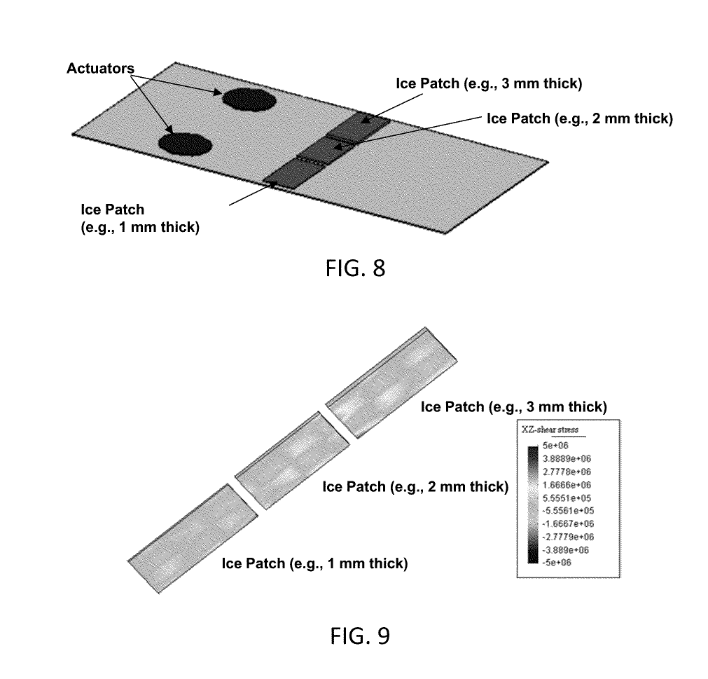

FIG. 8 shows a finite element method (FEM) model arrangement to predict the stress produced in a steel plate with an ice patch as shown for a given actuator loading condition. There are two circular actuators embedded on the plate as shown. Three different ice thickness layers are provided in the model, wherein the actuators transfer ultrasonic energy into the different ice substrate.

FIG. 9 shows the shear stresses occurring at the interface of the ice patches for the arrangement in FIG. 8. In this embodiment, the thicker ice patch has larger stresses at its interface than the two thinner patches.

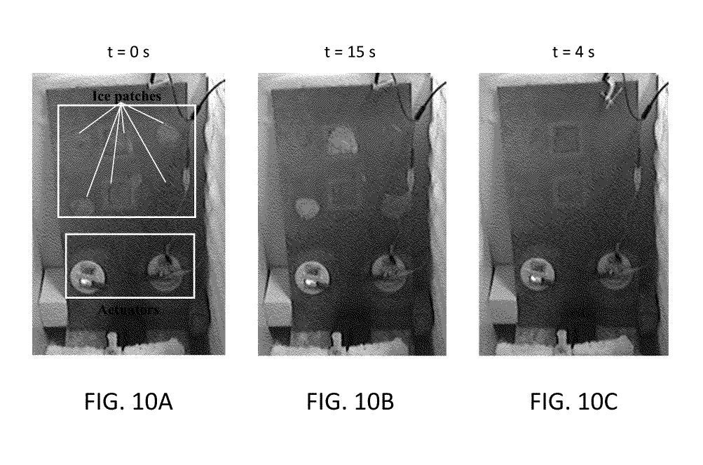

Referring to FIGS. 10A, 10B and 10C, the removal of ice layers from a steel plate using the ultrasonic frequency sweeping deicing approach is illustrated. In this example embodiment, two actuators were bonded to a 22 gauge steel plate with dimensions of 1 ft.×2 ft. Six ice patches were then frozen to various positions on the plate. Ice patch thickness varied between 0.5-3 mm. The actuators were turned on and automated frequency sweeping software was used to continuously move the focal spots throughout the entire plate. Experimentation and modeling were used to determine the frequency sweeping range, increment, and duty cycle. A combination of frequency change and distance to the ice patches determined when deicing would occur, which in this example takes 15 s for complete deicing. As demonstrated in FIGS. 10A, 10B and 10C, some of the ice patches were completely delaminated within 4 s of turning the actuators on. Complete de-icing of the plate occurred after 15 s of continuous mode-tuning. The plate was positioned at the bottom of the freezer for the entire experiment and the ice patches were formed over a period of 15 hours.

FIG. 11 is a schematic of one non-limiting embodiment of an ice/contaminant removal system 500 that includes of one or more sets of actuators 501-1, 501-2, . . . 501-8 (actuators 501-8), and circuitry including one or more single- or multi-channel signal generators 502, one or more amplifiers 503-1, 503-2 (amplifiers 503), one or more impedance matching networks 504-1, 504-2 (impedance matching networks 504), one or more DC bias circuits 505-1, 505-5 (DC bias circuits 505), an impedance analyzer 506, a system controller 507, relay control circuits 513, and one or more relays 508-1, 508-2, 509, 510, 511, and 512. The amplifier isolation relays 508-1, 508-2 and impedance isolation relay 509 serve to connect or disconnect the amplifiers 503 and impedance analyzer 506, respectively, from the system. The amp/impedance switching relay 510 serves to switch the actuators from the amplifiers to the impedance analyzer and vice versa. The amplifier switching relays 511-1, 511-2, . . . 511-7 (amplifier switching relays 511) serve to individually switch each actuator set 501 from one amplifier to another (e.g., 503-1 to 503-2) for phase inversion (reversal) purposes. The phase inversion relays 512-1, 512-2, . . . 512-7 (“phase inversion relays 512”) serve to individually invert the polarity of each actuator set 501 for phased impedance measurement purposes. As described above, one or more transformers 802 can be implemented with system 500 to provide phase inversion or reversal. In some embodiments, a transformer 802, or a similar phase splitter circuit, is disposed between amplifiers 503 and relays 508 of the circuit of system 500 illustrated in FIG. 11.

In some embodiments, controller 507 includes a processor 514 and a non-transient machine-readable storage medium 515 that is in signal communication with processor 514. Processor(s) 514 may be any central processing unit (“CPU”), microprocessor, micro-controller, or computational device or circuit for executing instructions and be connected to a communication infrastructure (not shown). Processor(s) 514 are configured to transmit signals to and receive signals from the circuitry. For example, processor(s) 514 are configured to transmit signals to relates 508, 509, 511, 512 for changing the orientation of these relays. Various software embodiments are described in terms of this exemplary controller 507. After reading this description, it will be apparent to one of ordinary skill in the art how to implement the method using other computer systems or architectures. Examples of storage medium 515 include, but are not limited to, a random access memory (“RAM”) such as, for example, a hard disk drive and/or removable storage drive, representing an optical disk drive such as, for example, a DVD drive, a Blu-ray disc drive, or the like. Storage medium 515 can also be implemented, at least partially, as a read only memory such as an erasable programmable read only memory (“EPROM”), Flash memory, or the like), or a programmable read only memory (“PROM”)).

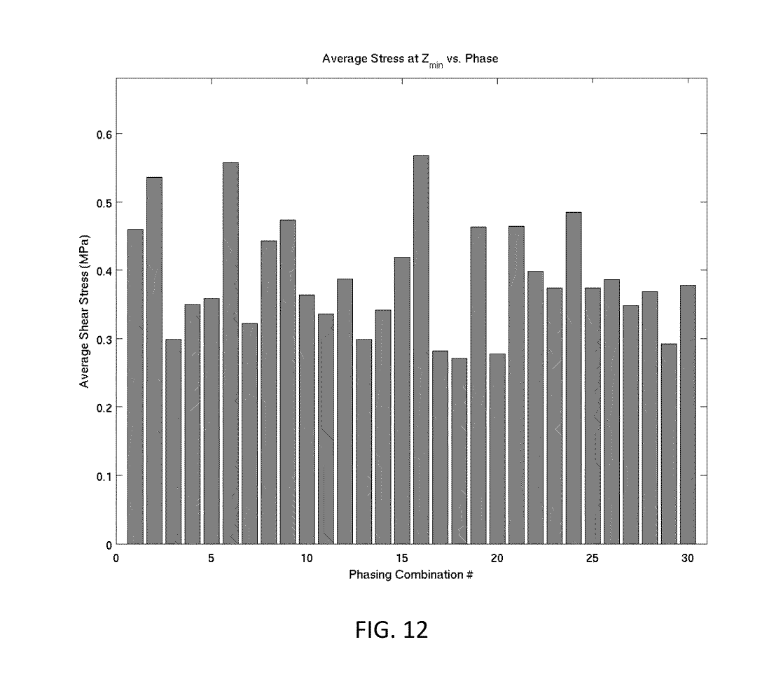

FIG. 12 is a bar graph displaying finite element modeling results of an ice-coated airfoil with 8 actuators. The amplitude of the bars indicates the average shear stress generated across the ice-airfoil interface by applying a 100-Volt input signal to each actuator using 30 unique actuator phasing combinations. The driving frequency for each phasing combination was determined by selecting the minimum impedance point on the phased impedance curves. This plot illustrates the fact that certain phasing combinations can yield much greater interfacial shear stresses than others when driven at the respective phased system resonant frequencies. Thus phasing, when appropriately performed, can greatly increase interface stresses generated by the system and thus more effectively remove ice or other contaminants.

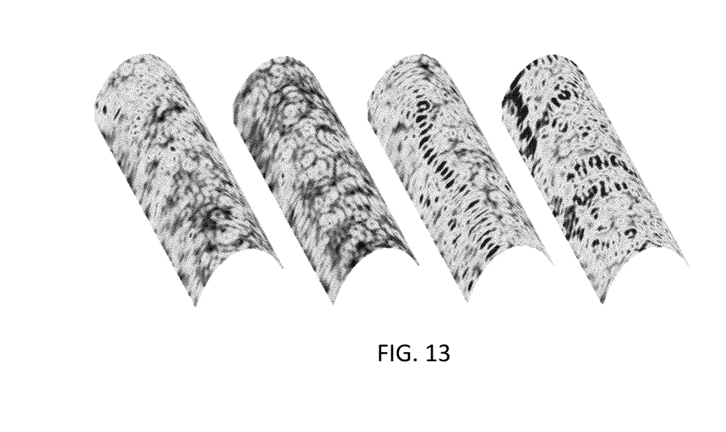

FIG. 13 illustrates one example of the redistribution of interfacial shear stresses achieved by actuator phasing. These results were generated from a finite element model of an ice-coated airfoil with 8 actuators. Each image represents the same ice-airfoil-actuator system operated with a different actuator phasing combination and driven at the respective phased system resonances. Note the variation in the locations of the local stress maxima as well as the potential gains in stress amplitude associated with phasing. Thus phasing, when appropriately performed, can improve the coverage area of shear stresses above a given threshold amplitude by both increasing the overall stress amplitudes and altering the distribution of stresses generated by the system.

FIG. 14 shows the subset of impedance curves measured in a four-actuator system as well as the directly-measured system impedance and the system impedance calculated using the method of combining the specially-selected subset of impedance curves, as described herein. This illustrates that the method of indirectly calculating the system impedance (phased or unphased) is accurate. Since direct measurement of the phased system impedance is not feasible, this method of indirect calculation is important. Additionally, this method of calculating the phased system impedance from the specially-selected subset allows for a dramatic reduction in the number of finite element models required to perform system optimization calculations.

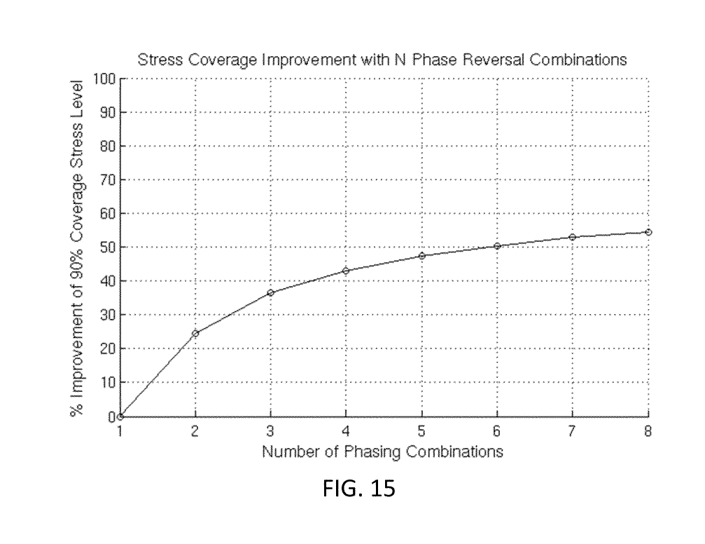

FIG. 15 illustrates the increase in interfacial shear stress in an ice-substrate system achieved by utilizing an increasing number of actuator phasing combinations. Specifically, the vertical axis indicates the shear stress threshold level for which 90% of the total of the ice-substrate interface experiences shear stresses equal to or greater than the indicated threshold level. The horizontal axis indicates the number of unique phasing combinations utilized by the system. For each phasing combination the system was operated at the appropriate phased system resonance. The single-phase result (i.e. “1” on the horizontal axis) corresponds to the unphased state of the system. Note that just a few phasing combinations can dramatically improve the 90% coverage threshold stress level. This results in greater ice/contaminant removal coverage and a greater ability to remove well-bonded ice/contaminants.

FIGS. 16A and 16B illustrate a 1:1 transformer 802 used to invert the actuator excitation signal for phase inversion as well as examples of possible input and output waveforms through such a transformer, which illustrate the induced phase shift. The phase inversion is achieved by wrapping the secondary coils 804 with an equal number of turns as the primary coils 803, but in the opposite direction. The use of a phase inversion device such as this would be beneficial since it would eliminate the need for a second signal generator as well as the need for a second amplifier, impedance matching network, and DC bias circuit. This could result in substantial weight and space savings.

FIG. 17 illustrates one method of fabricating an actuator and bonding it to a structure 602. Here a thin layer of low-viscosity epoxy 603 is used to bond the upper copper electrode tab 604 and lower copper electrode tab 605 to the electrode faces of the piezoelectric actuator 601 to create an electrical connection without the need for solder. The benefit of this bonding method over soldering is that it reduces the stress concentration factor of the joint, which greatly reduces the potential for actuator fracture during operation. Electrically-insulating layers 606, such as Kapton tape, and a layer of film epoxy 607 is applied between the electrodes to insulate them from one another. A layer of film epoxy 609 is applied to the top of the actuator to insulate it from the environment and another layer 608 is used to bond the actuator to the structure 602.

FIG. 18 is an image of an actuator electroded and bonded using the method described herein.

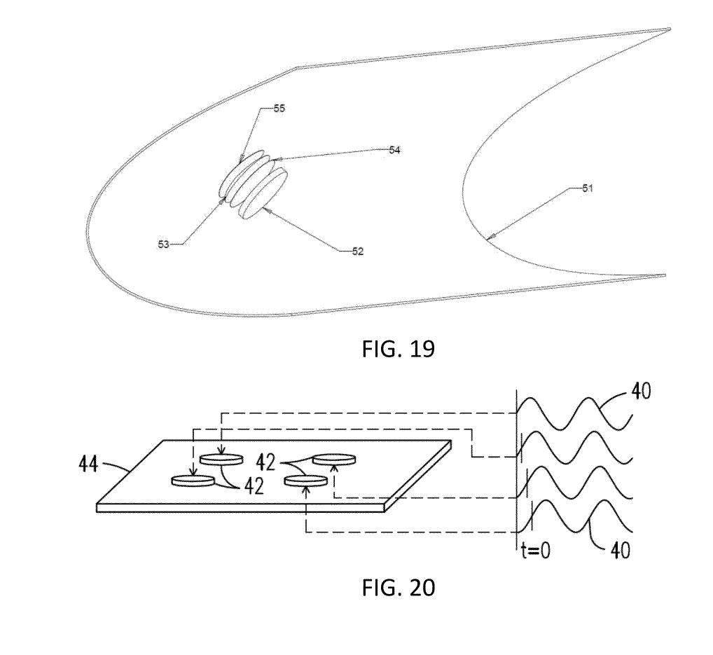

FIG. 19 illustrates the concept of using an intermediary wedge 53 to bond a flat actuator 52 onto a curved surface 51, such as an airfoil. Thin layers of film epoxy 54 and 55 are used to bond the three structures together. The actuator 701 could be constructed using the methods described herein and may be composed of multiple components or layers. The role of the intermediary wedge may also be replaced, in some embodiments, by fabricating conformal actuators that are fabricated or machined to match the curvature of the structure to which they are to be applied.

FIG. 20 illustrates the concept of continuous wave time delay phasing between actuators 42, in which the sinusoidal input signals 40 are phase-shifted with respect to one another. The precise phase shifts applied between actuators may be unique from one another, and one or more actuators may be operated in-phase with one another.

FIG. 21 shows two actuators 901 and 902 bonded to a structure 903. The impedance of the system in which actuators 901 and 902 are connected in parallel may be directly measured if the actuators are operated in-phase. However, if time delay phasing is applied to one of the actuators, the phased system impedance cannot be directly measured using an impedance analyzer since the effect of the applied phase delays cannot be directly accounted for during the measurement.

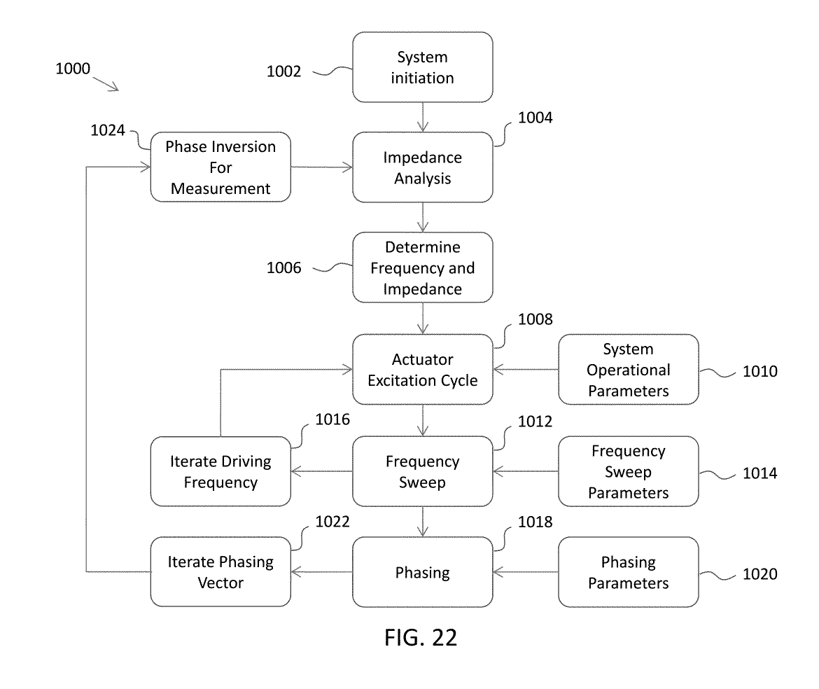

FIG. 22 is a flow diagram of one example of a method 1000 of removing and/or avoiding unwanted build-up on structures in accordance with some embodiments. At block 1002, a system, such as system 500 illustrated in FIG. 11, is initiated. In some embodiments, system initiation includes powering up controller 507 and/or other devices of system 500.

At block 1004, impedance analysis is performed. In some embodiments, impedance analysis is performed by impedance analyzer 506, which is coupled to controller 507 as shown in FIG. 11. In some embodiments, however, impedance analyzer 506 is included as a component of controller 507. As described above, impedance analysis can include indirectly calculating the system impedance by generating a plurality of impedance curves using Eq. 1 above and selecting a subset of curves. In some embodiments, impedance analysis is performed by utilizing a phase inversion approach and subsequently inverting the polarity of the actuators or actuator sets to which phase inversion is to be applied. The impedance of actuators is measured as is the cross-coupled impedance between each unique pair of actuators. For example, FIG. 14 illustrates the impedances for a four actuator system.

At block 1006, frequency and impedance parameters are determined. In some embodiments, the frequency at which the minimum impedance occurs is the selected frequency, and the impedance value at that minimum is used to adjust the impedance matching network(s). It is possible, for example, for the system to run off-resonance in which the selected frequency would not be at a minimum.

At block 1008, an actuator excitation cycle is performed. In some embodiments, an actuator excitation cycle is performed based on system operational parameters, which are received at block 1010 based on a driving frequency received from block 1016. The actuators 501 are driven in response to controller 507 sending signals to amplifiers 503 as illustrated in FIG. 11. In some embodiments, the system operational parameters are stored in a database residing in storage medium 515 and are either preset or entered by a user of controller 507 by using an input device (not shown in FIG. 11), such as a touchscreen, keyboard, mouse, trackball, keypad, voice recognition, or other device suitable for entering data.

At block 1012, a frequency sweep is performed. As described above, a frequency sweep includes driving actuators 501 (FIG. 11) at different frequencies within a finite frequency range. For example, the finite frequency can be in the range of 1 Hz to 500 MHz or another range of frequencies as set by the frequency sweep parameters received and/or stored at block 1014. In some embodiments, the frequency sweep parameters are stored in a database residing in storage medium 515 (FIG. 11) or are received from a user using an input device (not shown in FIG. 11) coupled to or part of controller 507.

At block 1016, an iterative frequency driving loop is formed and fed back to actuator excitation cycle. For example, as the frequency is swept, the actuators 501 (FIG. 11) are driven at these different frequencies.

At block 1018, phasing is performed. The phasing adjusts the phase shift to one or more of actuators 501 illustrated in FIG. 11. As described above, the use of phasing changes the impedance characteristics, which are dependent upon the specific actuator phasing combination as shown in FIG. 20. In some embodiments, for example, the phasing parameters received from a storage device 515 and/or retrieved from an input device (not shown in FIG. 11) being used by a user.

At block 1022, an iterative phasing vector loop is utilized to perform phase sweeping. In some embodiments, phase inversion of certain actuators at block 1024 is induced by inverting the polarity of those actuators before conducting the impedance analysis at block 1004. In some embodiments, as described above, the impedance measurement at block 1004 includes measuring the impedance Zᵢ of each individual actuator 501 (FIG. 11), i, as well as the cross-coupled impedances Zᵢⱼ between each actuator i and j (defined as the current induced in actuator j divided by the voltage applied to actuator i. The impedance analysis is performed at block 1004 using Eq. 1 above.

The ultrasonic vibration approach can also be used for nondestructive testing or structural health monitoring. The purpose here is to develop a new ultrasonic vibration technique to bridge the gap between ultrasonic wave propagation and lower frequency modal analysis vibration methods in nondestructive evaluation and structural health monitoring in order to find defects with intermediate size compared to the more standard ultrasonic non deconstructive testing and structural health monitoring testing techniques.

As an example, in ultrasonic practices it may be possible to detect a 0.010″ long defect; in a vibration or modal vibration approach it might be possible to detect a defect on the order of 5″ in length. In some embodiments, the ultrasonic vibration technique disclosed herein may be able to detect defects on the order or 0.5″ long.

The systems, methods, and apparatuses disclosed herein can be used to inspect odd shaped parts with different attachment considerations or boundary conditions and even hidden, coated, or insulated parts as long as a small section is accessible.

For example, the ultrasonic modal analysis result will depend on the initial ultrasonic loading function. The loading function is associated with an ultrasonic sensor design based on dispersion curve analysis and corresponding wave structure to achieve special sensitivity to certain kinds of defects. In plane and out of plane displacements are selected at any point across the structure to optimize defect detection sensitivity. The sensor can be a normal beam sensor of a certain diameter or it can be a comb type or annular array with specific segment spacing that would be able to get on to phase velocity dispersion curve at a specific point of interest. This loading function is to be able to create a wave structure across the thickness of the test object that would achieve a certain stress distribution or other wave parameter distribution to be able to have high sensitivity for finding a certain kind of defect after hundreds of reflections from the edges of the structures in somewhat preserving the wave structure until the long time solution occurs in which a modal vibration pattern is reached, either on or off resonance. Multiple loading functions, in a series of tests, may also be used to find and describe different kinds of situations.

The present invention can be embodied in the form of methods and apparatus for practicing those methods. The present invention can also be embodied in the form of program code embodied in tangible media, such as floppy diskettes, CD-ROMs, DVD-ROMs, Blu-ray disks, hard drives, solid-state drives, Flash memory drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method, comprising:
calculating, using a processor, an impedance of a phased system including a plurality of actuators disposed on a structure; and
activating the plurality of actuators disposed on the structure to produce shear stress via ultrasonic continuous wave activation to at least one of delaminate or weaken an adhesion strength of a contamination on the structure.

2. The method of claim 1, wherein calculating the impedance of the phased system includes:
determining an impedance of a subset of the plurality of actuators,
determining a cross-impedance of a subset of the plurality of actuators, and
determining the impedance of the phased system by at least applying appropriate phase shifts and mathematically combining the determined impedances and cross-impedances.

3. The method of claim 1, further comprising phasing of the plurality of actuators utilizing 180° phasing increments.

4. The method of claim 3, wherein the 180° phasing increments are achieved by changing an orientation of a relay coupled to the plurality of actuators.

5. The method of claim 3, wherein the 180° phasing increments are achieved by utilizing a phase-splitting circuit configured to induce 180° phase inversion.

6. The method of claim 1, further comprising:
adjusting a frequency at which the plurality of actuators are activated; and
adjusting a phase at which the plurality of actuators are activated.

7. A system, comprising:
a plurality of actuators configured to be coupled to a surface of a structure;
circuitry coupled to the plurality of amplifiers for driving the plurality of amplifiers; and
a controller coupled to the circuitry and including a processor and a non-transient machine readable storage medium in signal communication with the processor, the processor configured to:
calculate an impedance of the system, and
cause the plurality of actuators to be activated to produce shear stress via ultrasonic continuous wave activation to at least one of delaminate or weaken an adhesion strength of a contamination on the structure.

8. The system of claim 7, wherein the plurality of actuators is electroded and attached to a structure in the absence of a solder connection.

9. The system of claim 7, wherein the plurality of actuators is electroded and attached to a structure by an epoxy connection.

10. The system of claim 7, wherein the plurality of actuators is bonded to a curved surface of a structure using an intermediary wedge.

11. The system of claim 7, wherein the plurality of actuators conform to a curvature of a curved surface.

12. The system of claim 7, wherein when calculating the impedance of the system, the processor is configured to
determine an impedance of a subset of the plurality of actuators,
determine a cross-impedance of a subset of the plurality of actuators, and
determine the impedance of the phased system by at least applying appropriate phase shifts and mathematically combining the determined impedances and cross-impedances.

13. The system of claim 7, wherein the processor is configured to apply phasing using 180° phasing increments.

14. The system of claim 13, wherein the circuitry includes relays configured to change their orientations to generate the 180° phasing increments in response to a signal received from the processor.

15. The system of claim 7, wherein the circuitry includes a phase-splitting circuit configured to induce 180° phase inversion.

16. The system of claim 8, wherein the processor is configured to
adjust a frequency at which the plurality of actuators are activated, and
adjust a phase at which the plurality of actuators is activated.

17. A non-transient machine readable storage medium encoded with program code, wherein when the program code is executed by a processor, the processor performs a method, the method comprising
calculating an impedance of a phased system including a plurality of actuators disposed on a surface of a structure; and
causing the plurality of actuators to be activated to produce shear stress via ultrasonic continuous wave activation to at least one of delaminate or weaken an adhesion strength of a contamination on the structure.

18. The non-transient machine readable storage medium of claim 17, wherein calculating the impedance of the phased system includes:
determining an impedance of a subset of the plurality of actuators,
determining a cross-impedance of a subset of the plurality of actuators, and
determining the impedance of the phased system by at least applying appropriate phase shifts and mathematically combining the determined impedances and cross-impedances.

19. The non-transient machine readable storage medium of claim 17, wherein calculating the impedance of the phase system includes utilizing 180° phasing increments.

20. The non-transient machine readable storage medium of claim 19, wherein the 180° phasing increments are achieved by changing an orientation of a relay coupled to the plurality of actuators.

21. The non-transient machine readable storage medium of claim 17, wherein the method includes:
adjusting a frequency at which the plurality of actuators are activated; and
adjusting a phase at which the plurality of actuators is activated.

22. A method, comprising:
monitoring a forward power and a reflected power between one or more amplifiers and at least one actuator;
optimizing a frequency of excitation and a matched impedance of an ice/contaminant removal system; and
activating the at least one actuator disposed on a structure to produce a shear stress via ultrasonic continuous wave excitation to one of delaminate or weaken an adhesion strength of a contamination disposed on the structure.

23. The method of claim 22, wherein optimizing the frequency of excitation and the matched impedance includes performing one of a periodic and a continuous adjusting of the actuation of the at least one actuator.

24. The method of claim 22, wherein the forward power and the reflected power are monitored by a bi-directional coupler.
